(19) United States
(12) Patent Application Publication
(10) Pub. No.: US 2025/0310234 A1
(43) Pub. Date: Oct. 2, 2025

(54) METHOD AND SYSTEM FOR WIRELESS MULTI-HOP NETWORKING BASED ON DEVICE PROVISIONING PROTOCOL

(71) Applicant: Hitron Technologies Inc., Hsinchu City (TW)

(72) Inventors: DEYAN ZHANG, Hsinchu City (TW); XIAOWEI DAI, Hsinchu City (TW)

(21) Appl. No.: 18/789,703

(22) Filed: Jul. 31, 2024

(30) Foreign Application Priority Data
Mar. 28, 2024 (CN) 2024103626237

(51) Int. Cl. H04L 45/02; H04L 41/0803; H04L 45/17

(52) U.S. Cl. CPC H04L 45/02; H04L 41/0803; H04L 45/17

(57) ABSTRACT

The present invention discloses a method and a system for wireless multi-hop networking based on a device provisioning protocol (DPP). The method includes the steps of receiving DPP configuration information of a mobile station by a terminal unsupportive of the DPP, sending the DPP configuration information of the mobile station to an access point by a cloud, wherein the access point and the mobile station are both supportive of the DPP, and controlling the access point to network with the mobile station according to the DPP configuration information of the mobile station such that the access point and the mobile station are integrated into a wireless multi-hop network. This solution for wireless multi-hop networking enhances the compatibility and networking efficiency with reduced resource consumption.

### FIELD OF THE INVENTION

The present invention generally relates to the field of wireless local area networks and, more particularly, to a method and a system for wireless multi-hop networking based on a device provisioning protocol (DPP).

### BACKGROUND OF THE INVENTION

Mobile devices in existing technologies serve as configurators in the context of Easy Connect defined by the Wi-Fi Alliance, which requires mobile devices to support the device provisioning protocol (DPP). However, the mobile devices that support DPP are not widely used in the market.

### SUMMARY OF THE INVENTION

To address the above technical issues, the present disclosure provides a method and a system for wireless multi-hop networking based on a device provisioning protocol (DPP), which improves user experience with reduced resource consumption.

More particularly, the present disclosure provides the technical solutions as follows.

The present disclosure provides a method for wireless multi-hop networking based on a device provisioning protocol (DPP), including the steps of:
receiving DPP configuration information of a mobile station by a terminal unsupportive of the DPP;
sending the DPP configuration information of the mobile station to an access point by a cloud, wherein the access point and the mobile station are both supportive of the DPP; and
controlling the access point to network with the mobile station according to the DPP configuration information of the mobile station such that the access point and the mobile station are integrated into a wireless multi-hop network.

The terminal transitions from a configurator to a role that only forwards DPP configuration information. By interacting with the mobile station and the access point supportive of DPP through various ways, the terminal sends the DPP configuration information of the mobile station to the access point and completes creating and configuring the wireless multi-hop network between the access point and the mobile station. This approach enhances the compatibility and user experience of the networking solution.

In some embodiments, after the step of receiving the DPP configuration information of the mobile station by the terminal unsupportive of the DPP, the method includes the steps of:
controlling the terminal to transmit the DPP configuration information of the mobile station to the cloud;
controlling the cloud to verify the transmitted DPP configuration information of the mobile station and send the verified DPP configuration information of the mobile station to the access point; and
controlling the access point to network with the mobile station according to the verified DPP configuration information of the mobile station such that the access point and the mobile station are integrated into the wireless multi-hop network.

The terminal transmits the DPP configuration information of the mobile station to the cloud, and the cloud may decide whether or not to send the DPP configuration information to the access point for networking, depending on the online or offline status of the access point. With this setting, the access point as a configurator and the mobile station as an enrollee need not be constantly active. When the access point is offline and the mobile station has completed sending the DPP configuration information, the mobile station can go offline. When the access point is online, the mobile station goes online and networks with the access point to complete the wireless multi-hop network therebetween. This design further enhances the compatibility and networking efficiency of the networking method disclosed herein with reduced resource consumption.

In some embodiments, the terminal interacts with the mobile station by means of Bluetooth, a QR code, or near-field communication (NFC).

In some embodiments, when the terminal interacts with the mobile station by means of Bluetooth and before the cloud sends the DPP configuration information of the mobile station to the access point, the method further includes the steps of:
controlling the terminal to receive a universally unique identifier (UUID) broadcasted by the mobile station by means of Bluetooth;
controlling the terminal to access the mobile station according to the UUID of the mobile station; and
controlling the terminal to send a DPP configuration information request to the mobile station by means of Bluetooth, and controlling the mobile station to provide feedback through a response carrying the DPP configuration information of the mobile station.

In some embodiments, when the terminal interacts with the mobile station by means of the QR code and before the cloud sends the DPP configuration information of the mobile station to the access point, the method further includes the steps of:
controlling the terminal to scan the QR code of the mobile station to obtain a UUID and the DPP configuration information of the mobile station; and
controlling the terminal to access the mobile station according to the UUID of the mobile station.

In some embodiments, when the terminal interacts with the mobile station by means of NFC and before the cloud sends the DPP configuration information of the mobile station to the access point, the method further includes the steps of:
controlling the terminal to obtain a UUID and the DPP configuration information of the mobile station by means of NFC when the distance between the mobile station and the terminal is less than a preset distance; and
controlling the terminal to access the mobile station according to the UUID of the mobile station.

In some embodiments, when the terminal further interacts with the access point by means of Bluetooth and before the cloud sends the DPP configuration information of the mobile station to the access point, the method further includes the steps of:
controlling the terminal to receive a UUID broadcasted by the access point by means of Bluetooth;
controlling the terminal to send a first authentication command to the access point according to the UUID of the access point; and
controlling the access point to access the cloud according to the first authentication command.

The present disclosure further provides a system for wireless multi-hop networking based on a device provisioning protocol (DPP), including:
a cloud;
a mobile station and an access point, both supportive of the DPP; and
a terminal, interacting with the mobile station and configured to receive DPP configuration information sent by the mobile station and transmit the DPP configuration information of the mobile station to the cloud, wherein the terminal is unsupportive of the DPP,
wherein the cloud verifies the transmitted DPP configuration information of the mobile station and sends the verified DPP configuration information of the mobile station to the access point; and the access point networks with the mobile station according to the verified DPP configuration information of the mobile station such that the access point and the mobile station are integrated into a wireless multi-hop network.

In some embodiments, the terminal interacts with the mobile station by means of Bluetooth, and the mobile station sends UUID to the terminal through Bluetooth broadcasting; the terminal is further configured to access the mobile station according to the UUID of the mobile station; and the terminal sends a DPP configuration information request to the mobile station by means of Bluetooth after the mobile station accesses the terminal.

In some embodiments, the terminal interacts with the mobile station by means of a QR code, and the terminal is further configured to scan the QR code of the mobile station to obtain a UUID and the DPP configuration information of the mobile station; and the terminal accesses the mobile station according to the UUID of the mobile station.

In some embodiments, the terminal interacts with the mobile station by means of near-field communication (NFC), and the terminal obtains a UUID and the DPP configuration information of the mobile station by means of NFC when the distance between the mobile station and the terminal is less than a preset distance; and the terminal accesses the mobile station according to the UUID of the mobile station.

In some embodiments, the terminal further interacts with the access point by means of Bluetooth, and the access point sends a UUID to the terminal through Bluetooth broadcasting; the terminal sends a first authentication command to the access point according to the UUID of the access point; and the access point accesses the cloud according to the first authentication command.

Compared with the existing technologies, the present invention offers at least one of the following beneficial effects.

Firstly, the terminal transitions from a configurator to a role that only forwards DPP configuration information. By interacting with the mobile station and the access point supportive of DPP through various ways, the terminal sends the DPP configuration information of the mobile station to the access point and completes creating and configuring the wireless multi-hop network between the access point and the mobile station. This approach enhances the compatibility and user experience of the networking solution.

Secondly, the terminal transmits the DPP configuration information of the mobile station to the cloud, and the cloud may decide whether or not to send the DPP configuration information to the access point for networking, depending on the online or offline status of the access point. With this setting, the access point as a configurator and the mobile station as an enrollee need not be constantly active. When the access point is offline and the mobile station has completed sending the DPP configuration information, the mobile station can go offline. When the access point is online, the mobile station goes online and networks with the access point to complete the wireless multi-hop network therebetween. This design further enhances the compatibility and networking efficiency of the networking method disclosed herein with reduced resource consumption.

### BRIEF DESCRIPTION OF DRAWINGS

The above-mentioned technical features, advantages and implementations of the present invention will become apparent from the following description of preferred embodiments with reference to the accompanying drawings.

FIG. 1 is a flowchart of a method for wireless multi-hop networking based on the DPP according to one embodiment of the present invention;

FIG. 2 is a flowchart of a method for wireless multi-hop networking based on the DPP according to one embodiment of the present invention;

FIG. 3 is a flowchart of a method for wireless multi-hop networking based on the DPP according to another embodiment of the present invention; and

FIG. 4 is a schematic diagram of a Bluetooth framework format based on the GATT specification according to one embodiment of the present invention.

### DETAILED DESCRIPTION OF THE INVENTION

In order to explain the embodiments of the present invention or the technical solutions in the prior art more clearly, the specific implementations of the present invention will be described in detail with reference to the accompanying drawings. Apparently, the drawings described below are merely some embodiments of the present invention. According to these drawings, those of ordinary skill in the art can obtain other drawings and adopt other implementation without creative efforts.

To maintain simplicity in the drawings, only the parts related to the invention are schematically shown in each figure, and they do not represent the actual structure of a product. In addition, for simplicity and ease of understanding, in some drawings, only one component is schematically illustrated or marked even if multiple components with the same structure or function are present. As used herein, “a” may refer to “only one” or “more than one”.

Further, it should be understood that the term “and/or” used herein refers to and includes any and all possible combinations of one or more of the associated listed items.

In addition, as used herein, the terms “first”, “second”, etc. are merely to distinguish components and should not be interpreted as indicating or implying relative importance.

It should be noted that the embodiments can be freely combined as needed. The embodiments are only preferred implementations of the present invention. It should be pointed out that, for those of ordinary skill in the art, several improvements and modifications can be made without departing from the concept of the present invention. Such improvements and modifications should also be included within the scope of the present invention.

Before elaborating on the solutions described herein, the terms used in the present disclosure are first introduced. The “wireless multi-hop network,” also known as the multi-hop wireless network, is a wireless network architecture that relies on the mutual cooperation between nodes to transmit information. In this kind of network, each node can serve both as a sender and a receiver of information and as a repeater to help other nodes forward information. The “wireless mesh network”, which is a common type of wireless multi-hop network, is used interchangeably with wireless multi-hop network in the present disclosure. In a wireless mesh network, the device as a configurator usually interacts with various devices as enrollees to obtain related DPP configuration information, thereby completing the networking of the wireless mesh network.

As used herein, the term “DPP (device provisioning protocol)” refers to a device configuration protocol for simplifying the process of adding new devices to a wireless network. The DPP protocol was launched by the Wi-Fi Alliance (WFA) as part of the WPA3 security suite to replace the earlier Wi-Fi Protected Setup (WPS). The main purpose of DPP is to enhance network security while simplifying the device connection process.

As used herein, a “configurator” can serve as a controller that assists different devices in accessing a wireless LAN and configuring an access point (AP). An “enrollee” typically refers to a device that needs to be connected to the network and configured. Such device may be an access point (AP), or it may be a terminal device serving as a station (STA).

As used herein, an “access point” refers to a device that provides connection services in a wireless mesh network. In other words, an access point can be any device that allows user terminals to access the services they need. For example, it can be a stand-alone device or be integrated into a router. A “station (referred to as a mobile station in the present disclosure)” refers to a user device connected to a wireless network, such as a smartphone, a laptop, a tablet, etc.

As mentioned above, in a wireless multi-hop network, the device as a configurator can interact with the device as an enrollee to obtain the DPP configuration information of the device as an enrollee. After DPP authentication, DPP configuration and DPP connection, the networking of the device as a configurator with the device as an enrollee in a wireless multi-hop network can be completed.

Furthermore, Wi-Fi Easy Connect™ Specification Version 3.0 launched by the Wi-Fi Alliance indicates that DPP configuration information can be obtained or forwarded by means of various ways such as NFC, low-power Bluetooth, QR codes, and hardware buttons. In the conventional methods for creating and configuring wireless multi-hop networks, when a terminal as a configurator obtains DPP configuration information of other devices as an enrollee for wireless mesh networking or DPP configuration information networking by means of NFC, low-power Bluetooth, QR codes, or hardware buttons, the terminal must be supportive of the DPP. The process of wireless multi-hop networking between an enrollee and a terminal serving as a configurator in the prior art is introduced as follows.

Specifically, when a mobile terminal serves as a configurator and an access point serves as an enrollee, the mobile terminal scans the QR code or NFC tag of the access point to complete the wireless multi-hop network between the mobile terminal and the access point. Subsequently, the mobile terminal, which has accessed the wireless multi-hop network, scans the QR codes or NFC tags of other devices serving as enrollees (such as mobile terminals, computers, printers, etc.) to obtain related DPP configuration information. Further, the mobile terminal, according to the DPP configuration information, performs DPP authentication, DPP configuration on the device serving as an enrollee, and finally completes a wireless multi-hop network between the device serving as an enrollee and the access point. Therefore, the mobile terminal must be supportive of DPP when it serves as a configurator. However, most of the current mobile terminals are unsupportive of DPP. There are significant limitations when connecting the device serving as an enrollee to a wireless multi-hop network through mobile terminals.

The present disclosure provides a method for connecting a device serving as an enrollee to a wireless multi-hop network via a terminal unsupportive of DPP. In this method, the terminal acquires the DPP configuration information of the enrollee and a cloud sends it to a configurator, which then completes wireless multi-hop networking with the enrollee based on the DPP configuration information of the enrollee. The terminal serves merely as a bridge for obtaining the DPP configuration information of the enrollee, allowing users to establish connection between multiple devices that are supportive of DPP through a terminal that is unsupportive of DPP, thus enhancing user experience and broadening the application scenarios for wireless multi-hop networking.

The present disclosure also provides a process for the flow of DPP configuration information. In this process, a terminal acquires the DPP configuration information from enrollees by means of low-energy Bluetooth (BLE), NFC, or QR code scanning, and the acquired DPP configuration information is then sent to a configurator. The configurator completes DPP authentication, DPP configuration, and connection with the enrollees according to the DPP configuration information of the enrollees to finally accomplish the networking of a wireless multi-hop network with the enrollees. It can be understood that the terminal in the present disclosure is not limited to mobile devices, computers, printers, wireless routers, etc. Any device that supports connectivity via at least one of Bluetooth, NFC, and QR code scanning as well as internet access can serve as the terminal in the present disclosure.

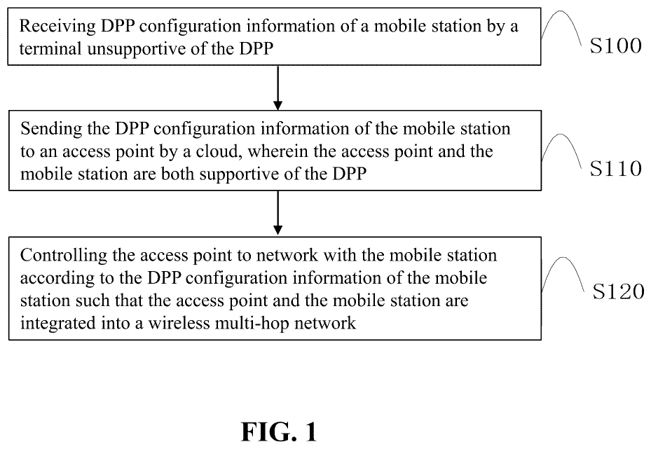

The terminal and the mobile station disclosed herein interact by means of Bluetooth, NFC, or QR code scanning to obtain DPP configuration information of the mobile station. However, before the terminal obtains the DPP configuration information of the mobile station, it is required that the terminal registers an access point with the cloud. During the process of registering the access point with the cloud, the terminal may acquire a universally unique identifier (UUID) of the access point by means of Bluetooth, NFC, or QR code scanning, control the access point to perform an onboard operation, and connect the access point to the cloud. Once the access point is connected to the cloud, a user can check through the cloud whether the access point is online when the terminal obtains and transmits the DPP configuration information of the mobile station to the cloud. If the access point is offline, the cloud can wait for the access point to come online before sending the DPP configuration information of the mobile station to the access point, so that the access point and the mobile station can successfully complete a wireless multi-hop network therebetween. This improves the efficiency of networking a wireless multi-hop network between devices with reduced power consumption. The following description is to explain in detail, with reference to FIG. 1, the present invention where the terminal interacts with the mobile station and the access point in various ways.

Referring to FIG. 1, the present disclosure provides a method for wireless multi-hop networking based on a device provisioning protocol (DPP), including the following steps.

In Step S100, a terminal unsupportive of the DPP receives DPP configuration information of a mobile station.

In Step S110, a cloud sends the DPP configuration information of the mobile station to an access point. The access point and the mobile station are both supportive of the DPP.

In Step S120, the access point is controlled to network with the mobile station according to the DPP configuration information of the mobile station such that the access point and the mobile station are integrated into a wireless multi-hop network.

In this embodiment, the mobile station and the access point are both supportive of the DPP. Before the wireless multi-hop networking of the mobile station with the access point, the access point is activated and connected to the Internet. A mobile application on the terminal records the identity information of the access point in the cloud. A specific process involves the terminal obtaining a universally unique identifier (UUID) of the access point by means of Bluetooth, QR code scanning, NFC, or the like. After the terminal identifies the UUID of the access point, the access point is controlled to perform onboard operations as prompted by a mobile application issued by the terminal to register the access point with the cloud.

If the terminal interacts with the access point by means of Bluetooth, the access point broadcasts the UUID to the terminal by means of Bluetooth. After identifying the UUID of the access point, the terminal sends a first authentication command (in this embodiment, the first authentication command is the prompt of the mobile application to perform onboard operations) to the access point, enabling registering the access point with the cloud according to the first authentication command. The terminal can also obtain the UUID of the access point by scanning the QR code of the access point and issue a first authentication command to register the access point with the cloud. When the distance between the terminal and the access point is less than a preset first distance, the terminal can obtain the UUID of the access point by means of NFC and issue a first authentication command to register the access point with the cloud. It can also be conceived that if the terminal has writing capability, the UUID of the access point can be directly input into the terminal to register the access point with the cloud.

Further, after the access point is registered with the cloud, the terminal connects to the mobile station by means of Bluetooth, NFC, or QR code scanning. It is understood that the methods of registering the access point with the cloud and accessing the mobile station to the terminal can be freely combined according to actual situations and are not limited herein.

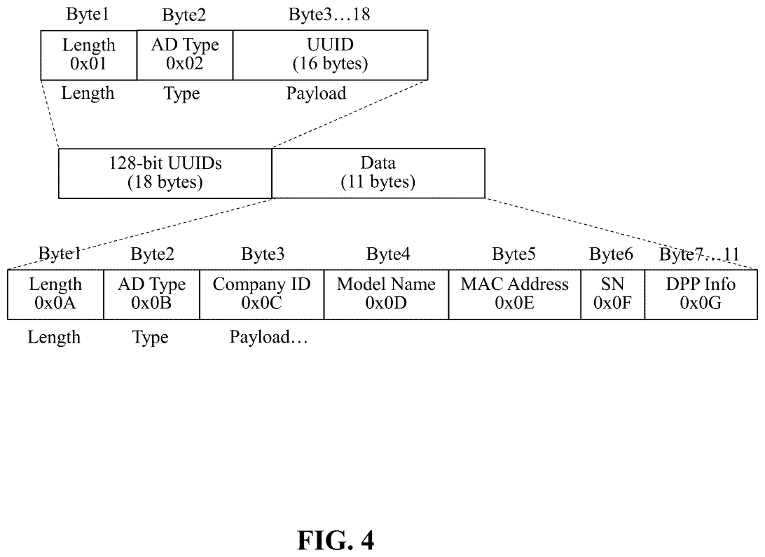

Further, when the terminal interacts with the mobile station by means of Bluetooth (referring to FIG. 4 for the Bluetooth framework format defined in this embodiment based on the GATT specification), the mobile station broadcasts its UUID to the terminal by means of Bluetooth. After identifying the UUID of the mobile station, the terminal connects to the mobile station and returns a request to obtain the DPP configuration information of the mobile station. The mobile station sends the DPP configuration information to the terminal in response to the request, and the terminal forwards the DPP configuration information of the mobile station to the cloud for verification. After completing the verification, the cloud sends the verified DPP configuration information of the mobile station to the access point. According to the verified DPP configuration information of the mobile station, the access point performs DPP authentication, DPP configuration, and DPP connection to accomplish the wireless multi-hop networking.

When interacting with the mobile station by scanning a QR code, the terminal obtains the DPP configuration information and a UUID of the mobile station by means of the QR code of the mobile station. After the terminal identifies the UUID of the mobile station, the mobile station is connected to the terminal and the DPP configuration information of the mobile station is forwarded to the cloud for verification. After completing the verification, the cloud sends the verified DPP configuration information of the mobile station to the access point. According to the verified DPP configuration information of the mobile station, the access point networks with the mobile station, and the wireless multi-hop network therebetween is established.

When interacting with the mobile station by means of NFC, the terminal obtains the UUID and the DPP configuration information of the mobile station by means of NFC if the distance between the mobile station and the terminal is less than a preset distance. After the terminal identifies the UUID of the mobile station, the mobile station is connected to the terminal and the DPP configuration information of the mobile station is forwarded to the cloud for verification. After completing the verification, the cloud sends the verified DPP configuration information of the mobile station to the access point. Thus, according to the verified DPP configuration information of the mobile station, the access point networks with the mobile station, and the wireless multi-hop network therebetween is established.

In this embodiment, the terminal transitions from a configurator to a role that only forwards DPP configuration information. By interacting with the mobile station and the access point supportive of DPP through various ways, the terminal sends the DPP configuration information of the mobile station to the access point and completes creating and configuring the wireless multi-hop network between the access point and the mobile station. This approach enhances the compatibility and user experience of the networking solution.

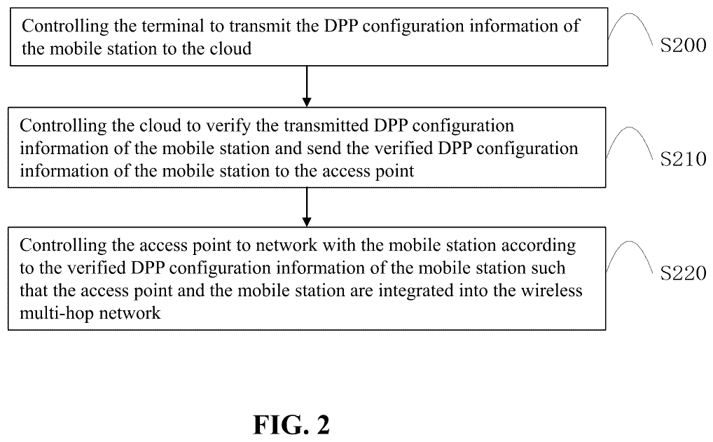

During the process of registering the access point with the cloud, the cloud records the first identity information of the access point (in this embodiment, the first identity information is the MAC address or serial number of the access point). Similarly, during the process of accessing the mobile station to the terminal, the terminal obtains the second identity information of the mobile station (in this embodiment, the second identity information is the MAC address or serial number of the mobile station), and sends the second identity information and the DPP configuration information of the mobile station to the cloud for verification. The cloud only performs format verification of the DPP configuration information of the mobile station and does not perform any other processing. The cloud verification process is explained in detail below with reference to FIG. 2.

Referring to FIG. 2, the present disclosure provides a method for wireless multi-hop networking based on the DPP. After receiving the DPP configuration information of the mobile station by the terminal unsupportive of the DPP, the method includes the following steps.

In Step S200, the terminal is controlled to transmit the DPP configuration information of the mobile station to the cloud.

In Step S210, the cloud is controlled to verify the transmitted DPP configuration information of the mobile station and send the verified DPP configuration information of the mobile station to the access point.

In Step S220, the access point is controlled to networks with the mobile station according to the verified DPP configuration information of the mobile station such that the access point and the mobile station are integrated into the wireless multi-hop network.

In this embodiment, after the access point is registered with the cloud and the mobile station is accessed by the terminal, the terminal transmits the obtained DPP configuration information and the second identity information of the mobile station to the cloud. First, the cloud verifies the format of the DPP configuration information of the mobile station and searches its database for the first identity information of an access point that corresponds to the second identity information of the mobile station. If an access point corresponding to the second identity information is found, the cloud checks whether the access point comes online. If the corresponding access point is offline, the cloud waits for the access point to go online before sending the verified DPP configuration information of the mobile station. After the access point receives the verified DPP configuration information, the access point serves as a configurator to network with the mobile station, thereby establishing a wireless multi-hop network.

Further, in some embodiments of the present invention, the terminal transmits the DPP configuration information of the mobile station to the cloud. The cloud may determine whether or not to send the DPP configuration information to the access point for networking, depending on the online or offline status of the access point. With this setting, the access point as a configurator and the mobile station as an enrollee need not be constantly active. When the access point is offline and the mobile station has finished sending DPP configuration information, the mobile station can go offline. When the access point is online, the mobile station can come online and networks with the access point to complete the wireless multi-hop network therebetween. This design further enhances the compatibility and efficiency of the networking method disclosed herein with reduced resource consumption.

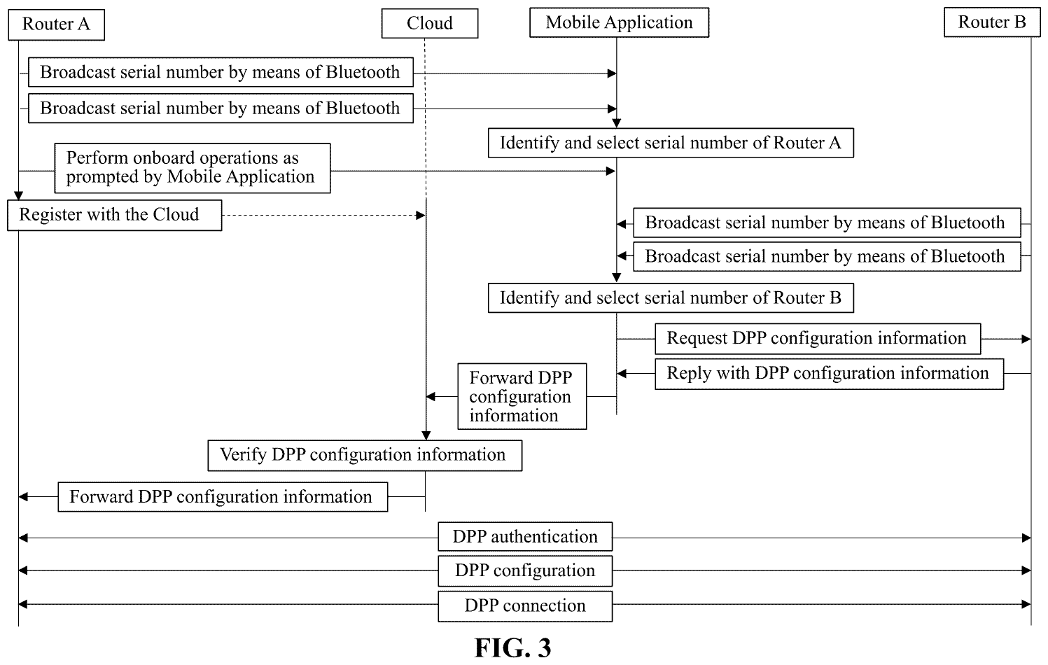

FIG. 3 shows another embodiment of the method disclosed herein for wireless multi-hop networking based on a device provisioning protocol (DPP). In FIG. 3, the terminal is a mobile device (in this embodiment, the terminal specifically refers to a mobile application on the mobile device in FIG. 3), the access point is Router A, and the mobile station is Router B.

Router A serves as an access point that is supportive of DPP, and Router B serves as a mobile station that is supportive of DPP. Router A is activated and connected to the Internet, and it sends its serial number to the mobile application on the mobile device by means of Bluetooth. Using the mobile application on the mobile device, identity information such as the MAC address or serial number of Router A is recorded into the cloud according to the prompts of the mobile application and is bound to a specific user as a gateway.

Furthermore, the mobile device scans identity information such as the MAC address or serial number broadcasted by means of Bluetooth by Router B, selects the corresponding MAC address, requests DPP configuration information from Router B according to the Bluetooth framework format based on the GATT specification defined in FIG. 4, and waits for Router B to reply with the DPP configuration information.

When receiving the DPP configuration information from Router B, the mobile device forwards the DPP configuration information along with the token information of the user account to the cloud. Upon receiving the information, the cloud verifies the format of the DPP configuration information and forwards the DPP configuration information to Router A after successful verification. When Router A receives the relevant DPP configuration information of Router B, a process including the DPP authentication, configuration, and connection with Router B is triggered, ultimately completing a wireless multi-hop network between Router A and Router B. It can be understood that, in this embodiment, the mobile station and the access point include but are not limited to network devices supporting Wi-Fi 6 or Wi-Fi 7 standards, such as wireless routers and wireless extenders.

The present disclosure further provides a system for wireless multi-hop networking based on a device provisioning protocol (DPP), which includes:
a cloud;
a mobile station and an access point, both supportive of the DPP; and
a terminal, interacting with the mobile station and configured to receive DPP configuration information sent by the mobile station and transmit the DPP configuration information of the mobile station to the cloud, wherein the terminal is unsupportive of the DPP;
wherein the cloud verifies the transmitted DPP configuration information of the mobile station and sends the verified DPP configuration information of the mobile station to the access point; and the access point networks with the mobile station according to the verified DPP configuration information of the mobile station such that the access point and the mobile station are integrated into a wireless multi-hop network.

In this embodiment, before the wireless multi-hop networking of the mobile station with the access point, the access point is activated and connected to the Internet. Through a mobile application on the terminal, the identity information of the access point is recorded in the cloud. A specific process involves the terminal obtaining a UUID of the access point by means of Bluetooth, QR code scanning, NFC, or the like. After the terminal identifies the UUID of the access point, the access point is controlled to perform onboard operations as prompted by the mobile application issued by the terminal, enabling registering the access point with the cloud.

Furthermore, the mobile station sends DPP configuration information to the terminal, and the terminal forwards the DPP configuration information of the mobile station to the cloud for verification. After completing the verification, the cloud sends the verified DPP configuration information of the mobile station to the access point. The access point performs DPP authentication, configuration, and connection according to the verified DPP configuration information of the mobile station to accomplish the wireless multi-hop networking.

The detailed description of this embodiment is set forth above and thus is not repeated hereafter to avoid redundancy.

The present disclosure further provides a system for wireless multi-hop networking based on a DPP, which is derived from the aforementioned embodiments of the networking system, wherein:
the terminal interacts with the mobile station by means of Bluetooth, and the mobile station sends a UUID to the terminal through Bluetooth broadcasting;
the terminal is further configured to access the mobile station according to the UUID of the mobile station; and
the terminal sends a DPP configuration information request to the mobile station by means of Bluetooth after the mobile station accesses the terminal.

In this embodiment, when the terminal interacts with the mobile station by means of Bluetooth (referring to FIG. 4 for the Bluetooth framework format defined in this embodiment based on the GATT specification), the mobile station broadcasts its UUID to the terminal by means of Bluetooth. After identifying the UUID of the mobile station, the terminal connects to the mobile station and returns a request to obtain the DPP configuration information of the mobile station. The mobile station sends the DPP configuration information to the terminal in response to the request, and the terminal forwards the DPP configuration information of the mobile station to the cloud for verification. After completing the verification, the cloud sends the verified DPP configuration information of the mobile station to the access point. According to the verified DPP configuration information of the mobile station, the access point performs DPP authentication, DPP configuration, and DPP connection to accomplish the wireless multi-hop networking.

The present disclosure further provides a system for wireless multi-hop networking based on a DPP, which is derived from the aforementioned embodiments of the networking system, wherein:
the terminal interacts with the mobile station by means of near-field communication (NFC), and the terminal obtains a UUID and the DPP configuration information of the mobile station by means of NFC when the distance between the mobile station and the terminal is less than a preset distance; and
the terminal accesses the mobile station according to the UUID of the mobile station.

In this embodiment, when interacting with the mobile station by means of NFC, the terminal obtains the UUID and the DPP configuration information of the mobile station by means of NFC if the distance between the mobile station and the terminal is less than a preset distance. After the terminal identifies the UUID of the mobile station, the mobile station is connected to the terminal and the DPP configuration information of the mobile station is forwarded to the cloud for verification. After completing the verification, the cloud sends the verified DPP configuration information of the mobile station to the access point. Thus, according to the verified DPP configuration information of the mobile station, the access point networks with the mobile station, and the wireless multi-hop network therebetween is established.

The present disclosure further provides a system for wireless multi-hop networking based on a DPP, which is derived from the aforementioned embodiments of the networking system, wherein:
the terminal interacts with the mobile station by means of a QR code, and the terminal is further configured to scan the QR code of the mobile station to obtain a UUID and the DPP configuration information of the mobile station; and
the terminal accesses the mobile station according to the UUID of the mobile station.

In this embodiment, when interacting with the mobile station by scanning a QR code, the terminal obtains the DPP configuration information and a UUID of the mobile station by means of the QR code of the mobile station. After the terminal identifies the UUID of the mobile station, the mobile station is connected to the terminal and the DPP configuration information of the mobile station is forwarded to the cloud for verification. After completing the verification, the cloud sends the verified DPP configuration information of the mobile station to the access point. According to the verified DPP configuration information of the mobile station, the access point networks with the mobile station, and the wireless multi-hop network therebetween is established.

The present disclosure further provides a system for wireless multi-hop networking based on a DPP, which is derived from the aforementioned embodiments of the networking system, wherein:
the terminal further interacts with the access point by means of Bluetooth, and the access point sends a UUID to the terminal through Bluetooth broadcasting;
the terminal sends a first authentication command to the access point according to the UUID of the access point; and
the access point accesses the cloud according to the first authentication command.

In this embodiment, when the terminal interacts with the access point by means of Bluetooth, the access point broadcasts the UUID to the terminal by means of Bluetooth. After identifying the UUID of the access point, the terminal sends a first authentication command (in this embodiment, the first authentication command is the prompt of the mobile application to perform onboard operations) to the access point, enabling registering the access point with the cloud according to the first authentication command. The terminal can also obtain the UUID of the access point by scanning the QR code of the access point and issue a first authentication command to register the access point with the cloud. When the distance between the terminal and the access point is less than a preset first distance, the terminal can obtain the UUID of the access point by means of NFC and issue a first authentication command to register the access point with the cloud. It can also be conceived that if the terminal is a device with writing capability, the UUID of the access point can be directly input into the terminal to register the access point with the cloud.

The present disclosure also provides a computer-readable medium on which a computer program is stored. When executed by a processor, the computer program implements the method for wireless multi-hop networking based on a DPP as described in the foregoing embodiments. The computer-readable medium can be any physical device or apparatus capable of carrying computer program codes, such as USB drives, mobile disks, magnetic disks, optical disks, computer memories, read-only memories, random access memories, etc.

It should be noted that the embodiments described above can be freely combined as needed. They are merely preferred embodiments of the present invention. It should be pointed out that for those skilled in the art, several improvements and modifications can be made without departing from the concept of the present invention. Such improvements and modifications should also be included within the scope of the present invention.

1. A method for wireless multi-hop networking based on a device provisioning protocol (DPP), comprising the steps of:
receiving DPP configuration information of a mobile station by a terminal unsupportive of the DPP;
sending the DPP configuration information of the mobile station to an access point by a cloud, wherein the access point and the mobile station are both supportive of the DPP; and
controlling the access point to network with the mobile station according to the DPP configuration information of the mobile station such that the access point and the mobile station are integrated into a wireless multi-hop network.

2. The method for wireless multi-hop networking based on the DPP according to claim 1, wherein the terminal interacts with the mobile station by means of Bluetooth, a QR code, or near-field communication (NFC).

3. The method for wireless multi-hop networking based on the DPP according to claim 1, comprising, after receiving the DPP configuration information of the mobile station by the terminal unsupportive of the DPP, the steps of:
controlling the terminal to transmit the DPP configuration information of the mobile station to the cloud;
controlling the cloud to verify the transmitted DPP configuration information of the mobile station and send the verified DPP configuration information of the mobile station to the access point; and
controlling the access point to network with the mobile station according to the verified DPP configuration information of the mobile station such that the access point and the mobile station are integrated into the wireless multi-hop network.

4. The method for wireless multi-hop networking based on the DPP according to claim 3, wherein the terminal interacts with the mobile station by means of Bluetooth, a QR code, or near-field communication (NFC).

5. The method for wireless multi-hop networking based on the DPP according to claim 4, further comprising, when the terminal interacts with the mobile station by means of Bluetooth and before the cloud sends the DPP configuration information of the mobile station to the access point, the steps of:
controlling the terminal to receive a universally unique identifier (UUID) broadcasted by the mobile station by means of Bluetooth;
controlling the terminal to access the mobile station according to the UUID of the mobile station; and
controlling the terminal to send a DPP configuration information request to the mobile station by means of Bluetooth, and controlling the mobile station to provide feedback through a response carrying the DPP configuration information of the mobile station.

6. The method for wireless multi-hop networking based on the DPP according to claim 4, further comprising, when the terminal interacts with the mobile station by means of NFC and before the cloud sends the DPP configuration information of the mobile station to the access point, the steps of:
controlling the terminal to obtain a UUID and the DPP configuration information of the mobile station by means of NFC when the distance between the mobile station and the terminal is less than a preset distance; and
controlling the terminal to access the mobile station according to the UUID of the mobile station.

7. The method for wireless multi-hop networking based on the DPP according to claim 4, further comprising, when the terminal interacts with the mobile station by means of NFC and before the cloud sends the DPP configuration information of the mobile station to the access point, the steps of:
controlling the terminal to obtain a UUID and the DPP configuration information of the mobile station by means of NFC when the distance between the mobile station and the terminal is less than a preset distance; and
controlling the terminal to access the mobile station according to the UUID of the mobile station.

8. The method for wireless multi-hop networking based on the DPP according to claim 5, further comprising, when the terminal further interacts with the access point by means of Bluetooth and before the cloud sends the DPP configuration information of the mobile station to the access point, the steps of:
controlling the terminal to receive a UUID broadcasted by the access point by means of Bluetooth;
controlling the terminal to send a first authentication command to the access point according to the UUID of the access point; and
controlling the access point to access the cloud according to the first authentication command.

9. The method for wireless multi-hop networking based on the DPP according to claim 6, further comprising, when the terminal further interacts with the access point by means of Bluetooth and before the cloud sends the DPP configuration information of the mobile station to the access point, the steps of:
controlling the terminal to receive a UUID broadcasted by the access point by means of Bluetooth;
controlling the terminal to send a first authentication command to the access point according to the UUID of the access point; and
controlling the access point to access the cloud according to the first authentication command.

10. The method for wireless multi-hop networking based on the DPP according to claim 7, further comprising, when the terminal further interacts with the access point by means of Bluetooth and before the cloud sends the DPP configuration information of the mobile station to the access point, the steps of:
controlling the terminal to receive a UUID broadcasted by the access point by means of Bluetooth;
controlling the terminal to send a first authentication command to the access point according to the UUID of the access point; and
controlling the access point to access the cloud according to the first authentication command.

11. A system for wireless multi-hop networking based on a device provisioning protocol (DPP), comprising:
a cloud;
a mobile station and an access point, both supportive of the DPP; and
a terminal, interacting with the mobile station and configured to receive DPP configuration information sent by the mobile station and transmit the DPP configuration information of the mobile station to the cloud, wherein the terminal is unsupportive of the DPP,
wherein the cloud verifies the transmitted DPP configuration information of the mobile station and sends the verified DPP configuration information of the mobile station to the access point; and
the access point networks with the mobile station according to the verified DPP configuration information of the mobile station such that the access point and the mobile station are integrated into a wireless multi-hop network.

12. The system for wireless multi-hop networking based on the DPP according to claim 11, wherein:
the terminal interacts with the mobile station by means of Bluetooth, and the mobile station sends a UUID to the terminal through Bluetooth broadcasting;
the terminal is further configured to access the mobile station according to the UUID of the mobile station; and
the terminal sends a DPP configuration information request to the mobile station by means of Bluetooth after the mobile station accesses the terminal.

13. The system for wireless multi-hop networking based on the DPP according to claim 11, wherein:
the terminal interacts with the mobile station by means of a QR code, and the terminal is further configured to scan the QR code of the mobile station to obtain a UUID and the DPP configuration information of the mobile station; and
the terminal accesses the mobile station according to the UUID of the mobile station.

14. The system for wireless multi-hop networking based on the DPP according to claim 11, wherein:
the terminal interacts with the mobile station by means of near-field communication (NFC), and the terminal obtains a UUID and the DPP configuration information of the mobile station by means of NFC when the distance between the mobile station and the terminal is less than a preset distance; and
the terminal accesses the mobile station according to the UUID of the mobile station.

15. The system for wireless multi-hop networking based on the DPP according to claim 12, wherein:
the terminal further interacts with the access point by means of Bluetooth, and the access point sends the UUID to the terminal through Bluetooth broadcasting;
the terminal sends a first authentication command to the access point according to the UUID of the access point; and
the access point accesses the cloud according to the first authentication command.

16. The system for wireless multi-hop networking based on the DPP according to claim 13, wherein:
the terminal further interacts with the access point by means of Bluetooth, and the access point sends the UUID to the terminal through Bluetooth broadcasting;
the terminal sends a first authentication command to the access point according to the UUID of the access point; and
the access point accesses the cloud according to the first authentication command.

17. The system for wireless multi-hop networking based on the DPP according to claim 14, wherein:
the terminal further interacts with the access point by means of Bluetooth, and the access point sends the UUID to the terminal through Bluetooth broadcasting;
the terminal sends a first authentication command to the access point according to the UUID of the access point; and
the access point accesses the cloud according to the first authentication command.
